(19) United States
(12) Patent Application Publication
(10) Pub. No.: US 2004/0009867 A1
(43) Pub. Date: Jan. 15, 2004

(54) Porous oxide ceramics and production thereof

(75) Inventors: Manuel E. Brito, Aichi (JP); Maria C. Valecillos, Aichi (JP); Naoki Kondo, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: National Inst. of Advanced Ind. Science and Tech., Tokyo (JP)

(21) Appl. No.: 10/338,836

(22) Filed: Jan. 9, 2003

(30) Foreign Application Priority Data
Jul. 15, 2002 (JP) 2002-204960

(51) Int. Cl. C04B 35/04; C04B 38/00

(52) U.S. Cl. 501/119; 501/80; 501/120

(57) ABSTRACT

This invention is a method of manufacturing oxide porous bodies and components of alumina and magnesia, using alumina and magnesia powders as raw materials, wherein (1) cold isostatic pressure (CIP) of at least 100 MPa is applied to the materials to introduce a plastic deformation with lattice disorder in the surface vicinity without external changes in the particles, (2) by sintering (calcining) the powders with the above described plastic deformation, the microscopic plastic deformation is removed and, at the same time, formation and growth of necks between grains is induced, (3) from the above described steps (1) and (2), a highly porous body with a structure constituted by a three dimensional network of grains connected through the necks is produced.

### BACKGROUND OF THE INVENTION

1. Field of the Invention

The present invention relates to a method of production of alumina or magnesia porous bodies with high mechanical strength and porosity, and particularly relates to the use of alumina and magnesia powders as raw materials, followed by the use of cold isostatic pressure (CIP) to introduce plastic deformation, and low temperature sintering (calcining) to promote the formation and growth of necks, resulting in a simple method for production of alumina and magnesia porous bodies with high mechanical strength and porosity.

The utility of this invention lies in the fact that alumina and magnesia porous bodies produced through the method described in this invention present a structure composed by a three dimensional network of high strength necks and combine excellent strength with a highly porous structure.

2. Description of the Related Art

Because of characteristics such as lightness, thermal stability, thermal shock resistance, chemical resistance, and high strength at room and at high temperature, alumina and magnesia porous bodies have become indispensable as industrial materials for use in filters (for gas separation, solid separation, bacterium and dust removal, etc.), catalytic carriers and separators.

Recently, alumina and magnesia porous bodies with higher porosity and higher strength are required for use in filters and catalytic carriers and separators. However, it is difficult to answer this demand with currently available sintering technologies for alumina and magnesia porous bodies, and it is evident the strong necessity for the development of a technology that allows the production of alumina or magnesia porous bodies with high strength and high porosity.

Current methods for production of carbides sintered compacts are based, for example, on imparting mechanically collision energy to heavy components through free fall or forced fall. By this method, the grains inside the carbide raw powders do not change and only microscopic strain is introduced in the crystal, shortening sintering times and allowing the sintering to be carried out under low pressure, to produce monolithic carbide sintered bodies. In this method, while collision energy provided to carbide raw powders acts as a driving force for sintering, by improving the efficiency in the production of monolithic sintered bodies, promotion of the formation and growth of necks between grains is to create a highly porous body is not the objective.

### SUMMARY OF THE INVENTION

This invention is a method of manufacturing oxide porous bodies and components of alumina and magnesia, using alumina and magnesia powders as raw materials, wherein (1) cold isostatic pressure (CIP) of at least 100 MPa is applied to the materials to introduce a plastic deformation with lattice disorder in the surface vicinity without external changes in the particles, (2) by sintering (calcining) the powders with the above described plastic deformation, the microscopic plastic deformation is removed and, at the same time, formation and growth of necks between grains is induced, (3) from the above described steps (1) and (2), a highly porous body with a structure constituted by a three dimensional network of grains connected through the necks is produced.

### BRIEF DESCRIPTION OF THE DRAWINGS

FIG. 1 shows defect structure of the raw powders.

FIG. 2 shows alumina grains showing microscopic plastic deformation with lattice disorder exclusively in the surface vicinity, after application of 100 MPa CIP.

FIG. 3 shows alumina grains showing microscopic plastic deformation with lattice disorder exclusively in the surface vicinity, after application of 500 MPa CIP.

FIG. 4 shows alumina grains after low temperature sintering at 1250° C. of grain with plastic deformation under different pressure conditions.

FIG. 5 shows neck structure of the alumina grains after low temperature sintering at 1250° C.

### DESCRIPTION OF THE PREFERRED EMBODIMENTS

Under these conditions, the present researchers have thoroughly revisited the current technologies with the aim of developing an easy method to produce alumina and magnesia porous bodies with high mechanical strength and porosity. Using magnesia and alumina as raw materials, this method is based on the application of cold isostatic pressure (CIP) to these powders in order to induce local plastic deformation, followed by low temperature sintering (Calcining) to induce the formation and growth of a three dimensional structure of necks in the alumina and magnesia porous bodies.

Summarizing, the method developed has as objective the production of highly porous bodies of alumina and magnesia with superb mechanical strength.

Using the above described method, this invention aims at the production of high strength high porosity alumina and magnesia porous bodies.

In addition, this invention presents a highly porous material constituted by the above described alumina and magnesia porous bodies.

To solve the above mentioned subjects, this invention includes the following technical steps and means:

(1) A method for production of porous oxides of alumina and magnesia using alumina and magnesia powders as raw material, comprising the steps of:

(a) applying cold isostatic pressure of at least 100 MPa to the above described powders, to introduce microscopic plastic deformation with lattice disorder at the surface vicinity, without changes in the external appearance of grains,

(b) calcining the grains that received the above described plastic deformation to remove the above described microscopic plastic deformation, and at the same time introduce formation and growth of necks between grains,

(c) producing, through the processes described in the above points (a) and (b), a highly porous body having grains forming a three dimensional network through neck connection.

(2) The method according to above (1), wherein pressure using cold isostatic pressure (CIP) technology is applied to a formed body of the above described powders.

(3) The method according to above (1), wherein a pressure of 100 to 500 MPa is applied to the above described powders, using cold isostatic pressure (CIP) technology.

(4) The method according to above (1), wherein the grains with the plastic deformation described above is sintered at a temperature lower than 1250° C.

(5) The method according to above (1), wherein the formation and grow of the necks, as well as the porosity of the porous body are controlled by adjusting the amount of the above described plastic deformation and the low temperature sintering conditions.

(6) The method according to above (5), wherein porosity of the porous body is controlled to be in the range from 33 to 38%.

(7) An oxide porous body having as characteristic the high porosity achieved through three dimensional connection of the grains through the necks, produced by the method described in any one of above (1) through (6).

(8) A porous member having a porous material with high mechanical strength and porosity, which contains as a constitutional element the oxide porous bodies described in above (7).

Following, a more detailed description of this invention is provided.

This invention relates to a method for production of porous oxides of alumina and magnesia which comprises taking alumina and magnesia powders as raw materials, apply cold isostatic pressure (CIP) of at least 100 MPa to the materials the introduce microscopic plastic deformation with lattice disorder in the surface vicinity, without changes in the external appearance of the grains, producing alumina and magnesia compacts that are sintered at relatively low temperature (calcining) to release the above described plastic deformation, inducing, simultaneously, the formation and growth of necks between grains and controlling the densification, and then obtaining a porous body with high porosity and with a structure characterized by a three dimensional network of grain connected through the above described necks.

As a result of the processes of manufacture of the alumina and magnesia as raw materials, defects such as dislocations and dislocation loops remain on the grain surface of these powders and, as it will be explained later in the example of execution, a defect structure is observed. The first step in this invention is the application of cold isostatic pressure of at least 100 MPa to these alumina and magnesia powders in order to introduce local plastic deformation with lattice disorder in the vicinity of the grain surface, at the contact boundaries between grains, without external deformation of the grains.

In this invention, the alumina and magnesia considered suitable for use as raw material are, but are not limited to, high purity oxide aluminum, hydrated alumina heat treated, oxide magnesium, and hydrated magnesium heat treated. The above described powders, for example, can be used to form green compacts through controlled application of pressure, but the formation is not limited to this method. In this invention, suitable green compacts of high purity α —Al₂ O₃ powders are used, but as it was mentioned above, alumina raw powders present a defect structure with large amounts of dislocation and dislocation loops on the surface of the grains, as well as large amounts of lattice defects inside the grains. Applying a cold isostatic pressure exceeding 100 MPa to these grains generates a large strain that introduces a high density of dislocation and strain at the grains contact region.

In this invention, pressure of 100 MPa or more is applied to the grains, through CIP. In this case, the pressurizing conditions are selected to ensure that there is not apparent deformation of the grains, but there is local plastic deformation with lattice disorder in the surface vicinity, 100 to 500 MPa is a typical example of this level of pressure. However, the suitable values are not limited to these examples. The second step of the present invention is sintering (calcining) at a set temperature resulting in the removal of the above described dislocations and defect structure, promoting the formation and growth of necks at most of the regions of contact between grains, controlling the densification in the vicinity of the necks to achieve a low density structure. Comparing these steps to the sintering processes currently in use for sintering of alumina and magnesia, it is evident the importance of a relatively low temperature sintering (calcining) of the grains, which, through the above described process, allows the production of a porous body with the required density and porosity (percentage of pores).

The sintering conditions for the low temperature sintering process have been selected in such a way that most of the above described dislocations and defect structure are removed, inducing the formation and growth of necks inter grains and controlling the density in the vicinity of the necks but ideally sintering is to be carried out at temperatures noticeable lower than temperatures usually selected for sintering of alumina and magnesia, in this case sintering is carried out at between 1100 to 1250° C. for short time (less than 1 hour).

However, these conditions are not limited to the ones here presented. In the present invention, the above described CIP and sintering (calcining) processes, it is possible to use, but are not limited to, conventional CIP and sintering equipment. In this invention, the above described combination of plastic deformation and sintering (calcining) at low temperature (less than 1250° C.) for a short time, induces the formation and growth of necks between grains, controlling the densification and making it possible to produce alumina and magnesia porous bodies. Both processes plastic deformation and sintering (calcining) are crucial to this invention, and it is important to notice that under traditional conditions of high temperature sintering, it is not possible to induce the formation of the above mentioned strong necks structure obtained in the present invention, and it is not possible to attain the expected objective if one of these steps is omitted.

In this invention, use of the specific structure above indicated promotes the formation and growth of necks between grains as well as low densification in the vicinity of these necks, producing alumina and magnesia porous bodies that present both high mechanical strength and high porosity (rate of pores) with superb necks strength. By regulating the above described plastic deformation and the conditions of low temperature sintering, the method in this invention, makes it possible to control the formation and growth of necks between grains, as well as the porosity of the porous body, which can be controlled to remain, for example, in the 33 to 38% range. However, the porosity is not limited to this range of values. Taking advantage of the high porosity and high mechanical strength of the he alumina and magnesia porous bodies produced by the method described in this invention, these materials have a wide field of applications as filter materials, catalyst carriers, or separator film in gas separation, solid separation, bacterium and dust removal, an other uses typical of the uses for porous ceramics. In this invention, the porous materials include all the materials used as porous ceramics.

This invention is characterized by the use of cold isostatic pressure (CIP) to introduce local plastic deformation between alumina and magnesia grains, inducing the formation and growth of necks between grains during sintering. In this invention, alumina and magnesia porous bodies can be produced by sintering at temperatures lower than the usual sintering temperatures generally used for sintering of alumina and magnesia, and, in consequence, the densification can be controlled and the formation and growth of necks between grains can be promoted, increasing the strength of the necks.

Compared to traditional alumina and magnesia porous bodies, the porous alumina and magnesia bodies sintered with the method in this invention present acceptable mechanical strength and high porosity. Accordingly, this invention presents an energy saving and easy to carry out method for the production of porous bodies of extremely good quality and improved reliability, when compared with traditional alumina and magnesia porous bodies, while, at the same time, the mistakes during the sintering process are largely reduced, improving in this way, the productivity. Compared to the traditional process for production of alumina and magnesia sintered bodies, this invention uses a much lower sintering temperature (less than 1250° C.) for low temperature sintering (calcining) and short sintering time to induce the formation and growth of necks to form a strong structure, allowing control of the densification to achieve a structure with a high porosity (high pore rate). Controlled application of cold isostatic pressure (CIP) and sintering, the required range of porosity (for example from 33 to 38%) can be achieved as the grains form a three dimensional network through the structure of strong necks, producing a high strength and high porosity structure that present characteristics not available, to date, in other alumina and magnesia sintered bodies.

### EXAMPLE

Next, this invention is explained based on a practical example, but this application does not limit, in any way, the scope of the invention.

### Practical Example 1

(1) Production of Multiporous Sintered Body

Slabs of green compacts were produced using pure α —Al₂O₃ powders (99.99%, 0.63 μm in meanparticle size, Si<40 ppm, K<40 ppm, Fe<40 ppm, Cu<10 ppm), and cold isostatic pressure of 100, 200, and 500 MPa was applied to produce samples corresponding to each pressure level. The samples were placed in alumina crucibles and underwent low temperature calcining in air in a resistance heating furnace. The calcining was carried out in the range of temperature from 1100 to 1250° C., with a holding time of one hour.

The density of the produced samples was measured by the Archimedes' method. Density values after calcining varied within the narrow range of 62 to 67%.

(2) Measurement Method

Transmission electron microscopy techniques were used to observe the degree of local plastic deformation imparted to the oxide particles by application of cold isostatic pressure (CIP), crucial to the development of this invention. Preparation of samples of porous ceramics for TEM observation was carried out by improving the ion beam milling techniques. The milling process was interrupted before a complete hole by the milling process was opened and TEM observation of the process was carried out under a low angle of incidence, allowing the observation of a crucial feature: the formation and growth of the necks between grains in the porous body. Also, the defect structure present in the alumina powders, as well as evolution of defects through the different steps that lead to the production of the porous sintered body (CIP, calcining), were recorded using the high angle annular dark field method (HAADF method).

(3) Results

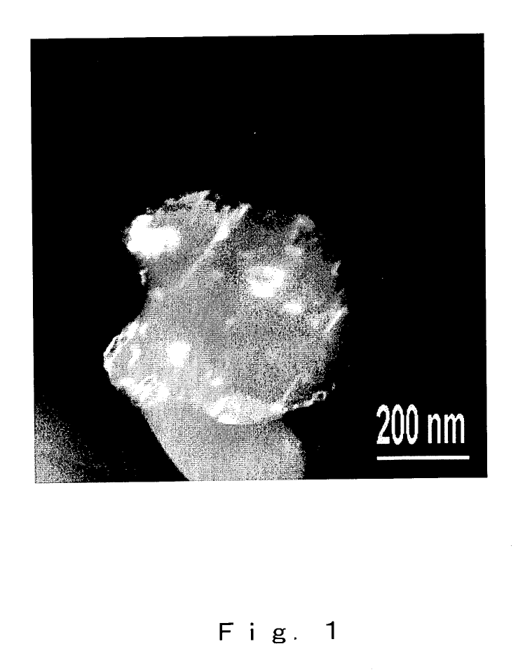

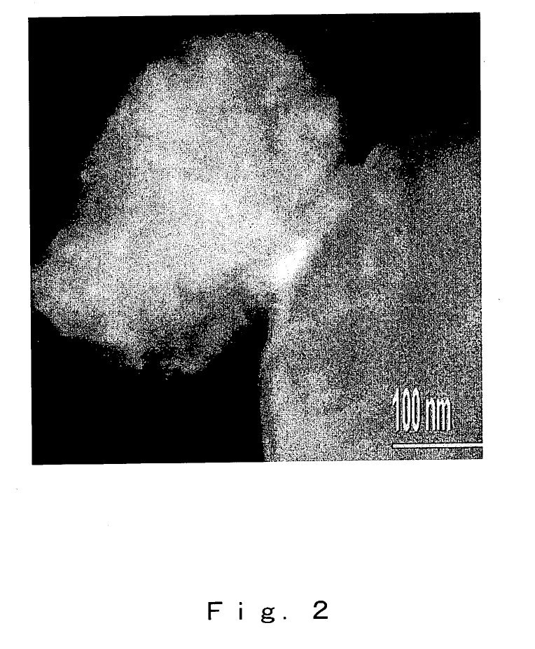

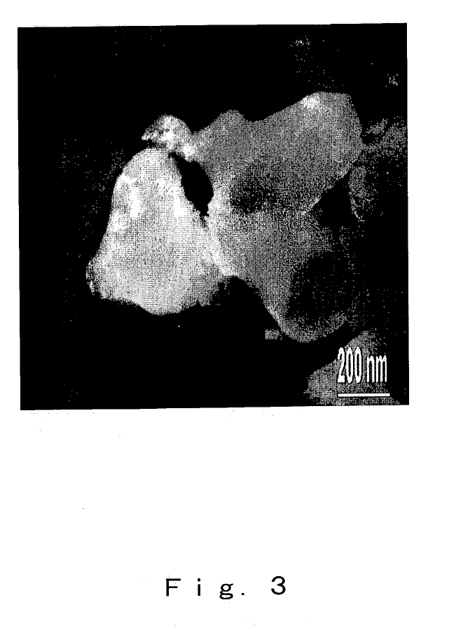

FIG. 1 corresponds to the low magnification HAADF image of the alumina raw powders, and shows the defect structure of the powder. The surface of the grains shows a large amount of dislocations and dislocation loops. There is not a special distribution inside the grains, but observation of the green alumina bodies at several pressure levels, showed a large amount of lattice defects in these bodies. FIG. 2 shows the high density of dislocations introduced at the contact points between grains after applying cold isostatic pressure of 100 MPa. Results from a pressure level of 500 MPa are shown in FIG. 3. This time, at the same time that a high density of dislocation is observed in the vicinity of a large number of contact points, a strong strain contrast is also observed. The high density of dislocations present in the TEM photographs become evidence of that cold isostatic pressure (CIP) introduce a momentarily large stress between grains.

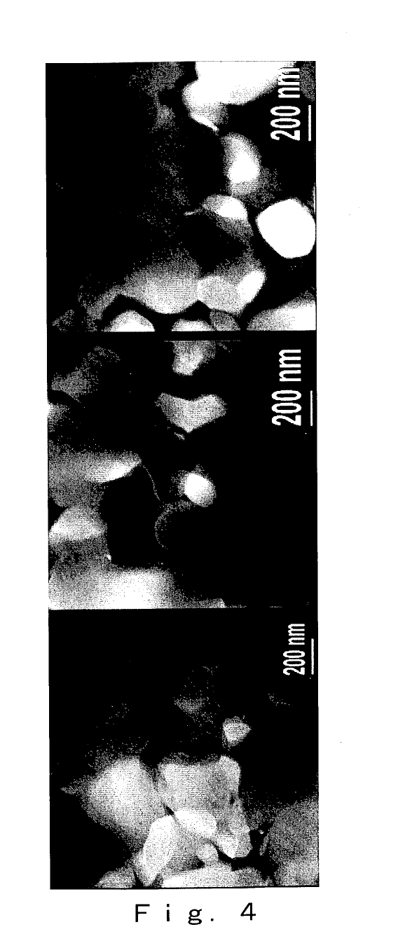

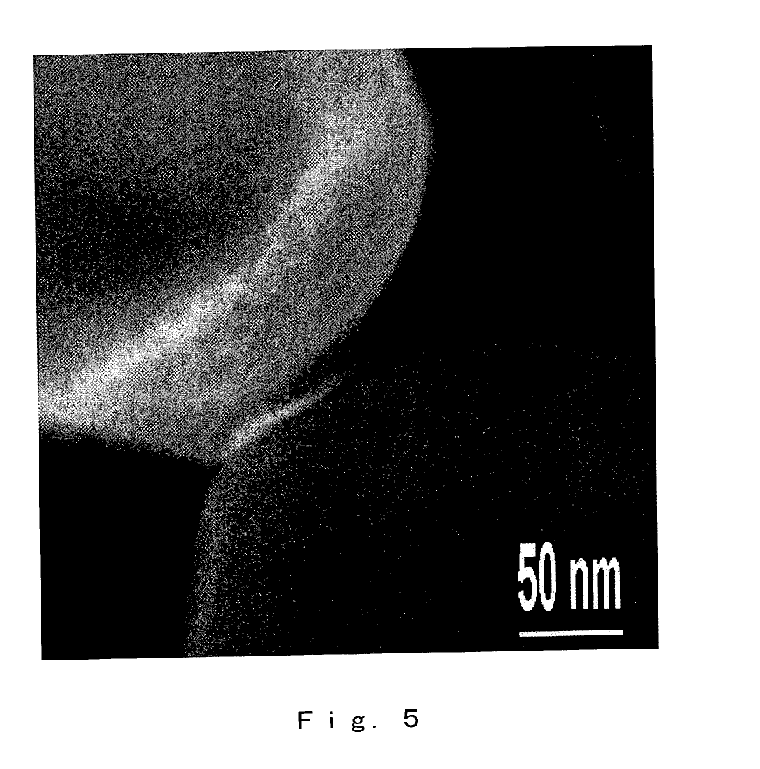

It is evident, from FIG. 4, that most of the dislocations introduced by cold isostatic pressure (CIP) of the powders disappear during sintering carried out at a temperature (1250° C.) remarkably lower than the temperature commonly used for sintering of alumina, and that the formation and growth of necks between grains progress as the pressure level changes. A possible mechanism for these phenomena is that surface diffusion is promoted by the introduction of lattice defects, that is, there is an increase in surface energy. FIG. 5, corresponds to a high magnification photograph of the necks formed and grown during sintering at a temperature of 1250° C. The vicinity of the necks shows low density and presents an ideal shape for the necks. Regarding the evaluation of the strength of the necks, the fact that the samples endured the process for TEM sample preparation (film production) becomes proof of the high strength of the alumina porous body produced.

From the results of the above described practical applications, it was confirmed that the alumina porous body produced in this application through the induction of formation and growth of necks between ceramic grains, present superb mechanical strength and high porosity.

As it was previously described, this invention deals with a method for production of porous oxide bodies using alumina and magnesia powders as raw materials, and the main results are 1) compared to manufacturing process for traditional alumina and magnesia sintered bodies, this is an energy saving and easy to carry out process for the manufacture of alumina and magnesia porous bodies, 2) combining CIP and low temperature sintering, it is possible to produce oxide porous bodies with the required amount of porosity, 3) it is possible to manufacture alumina and magnesia porous bodies with superb mechanical strength and high porosity, 4) adjusting the conditions of plastic deformation and sintering (calcining), it is possible to produce alumina and magnesia porous bodies with the desired porosity and mechanical strength.

What is claimed is:

1. A method for production of porous oxides of alumina and magnesia using alumina and magnesia powders as raw material, comprising the steps of:
(1) applying cold isostatic pressure of at least 100 MPa to the above described powders, to introduce microscopic plastic deformation with lattice disorder at the surface vicinity, without changes in the external appearance of grains,
(2) calcining the grains that received the above described plastic deformation to remove the above described microscopic plastic deformation, and at the same time introduce formation and growth of necks between grains,
(3) producing, through the processes described in the above points (1) and (2), a highly porous body having grains forming a three dimensional network through neck connection.

2. The method according to claim 1, wherein pressure using cold isostatic pressure (CIP) technology is applied to a formed body of the above described powders.

3. The method according to claim 1, wherein a pressure of 100 to 500 MPa is applied to the above described powders, using cold isostatic pressure (CIP) technology.

4. The method according to claim 1, wherein the grains with the plastic deformation described above is sintered at a temperature lower than 1250° C.

5. The method according to claim 1, wherein the formation and grow of the necks, as well as the porosity of the porous body are controlled by adjusting the amount of the above described plastic deformation and the low temperature sintering conditions.

6. The method according to claim 5, wherein porosity of the porous body is controlled to be in the range from 33 to 38%.

7. An oxide porous body having as characteristic the high porosity achieved through three dimensional connection of the grains through the necks, produced by the method described in any one of claims from 1 through 6.

8. A porous member having a porous material with high mechanical strength and porosity, which contains as a constitutional element the oxide porous bodies described in claim 7.
